(19) United States
(12) Patent Application Publication
(10) Pub. No.: US 2017/0095856 A1
(43) Pub. Date: Apr. 6, 2017

(54) Holding Device of a Forming Machine

(71) Applicant: Yen-Jung Liao, Dounan Township (TW)

(72) Inventor: Yen-Jung Liao, Dounan Township (TW)

(21) Appl. No.: 14/882,502

(22) Filed: Oct. 14, 2015

(30) Foreign Application Priority Data
Oct. 2, 2015 (TW) 104132640

(51) Int. Cl. B21D 43/10; B65G 47/90; B21D 43/05

(52) U.S. Cl. CPC B21D 43/105; B21D 43/05; B65G 47/90; B65G 2811/0626

(57) ABSTRACT

A holding device of a forming machine includes a base, a rotating set, a clamping set, and a transmission set. The rotating set penetrates through the base. The clamping set is disposed under the base. The transmission set drives a rotation of the rotating set. Further, the clamping set has a link axle and a link unit driven by the link axle in order to render two clamping units able to catch or release blanks. Simultaneously, the transmission set has a driving unit and a transmission unit adapted to drive a rotation of the driving unit whereby the link axle, the rotating base and the clamping unit are concurrently rotatably turned in a clockwise or counterclockwise direction by 180 degrees. Thus, the holding device can clamp blanks at any place between dies of the forming machine according to the need to obtain a quick processing operation.

### BACKGROUND OF THE INVENTION

1. Field of the Invention

This invention relates to a holding device and relates particularly to a holding device of a forming machine or a press forming machine.

2. Description of the Related Art

A typical processing operation of parts, such as screws and nuts, is to feed rods directly to a forming machine and cut the rods into blanks with a proper length. The blanks are then pressed by multiple dies of the forming machine. To facilitate the processing work, a clamping device is usually mounted between dies of the forming machine to clamp and move the blanks in sequence. Accordingly, the blanks can be subjected to different process in different steps of the processing operation. Therefore, the arrangement of the clamping device is important to the processing operation because the upward and downward movement, the displacement and the clamping and releasing behavior of the clamping device affect the pressed state of the blank. However, the typical processing operation can merely focus on the step of pressing one end of the blank. If two ends of the blank are to be pressed, the two ends have to be pressed one after the other owing to the clamping device which cannot turn. Hence, the typical design of the clamping device lowers the speed of the pressing process, requires many processing steps, causes the operation to be more complex, and creates a large number of defective goods. Thus, the cost cannot be reduced.

Therefore, some firms invent a rotatable clamping device to clamp and rotate the blank to the next processing after one end of the blank is finished pressing. In use, the clamping device limited by the immovable moving range cannot efficiently catch or release the blanks during the processing operation. To solve the problem, an auxiliary push unit is set between the dies to push the blank. In other words, the clamping device moves the blank to a place where the push unit is located, and the push unit pushes the blank forward, thereby allowing the clamping device to clamp the blank and subjecting the blank to a further pressing process. However, the added push unit inevitably increases the cost, and the processing operation becomes more complex and requires more processing steps. Thus, the processing speed is still affected, and this requires an improvement.

### SUMMARY OF THE INVENTION

The object of this invention is to provide a holding device of a forming machine which carries out a catching and releasing operation and a clockwise or counterclockwise rotation in order to largely increase the smoothness of the processing operation and attain a quick forming operation.

The holding device of the forming machine in accordance with this invention comprises a base, a rotating set penetrating through the base, a clamping set disposed under the base, and a transmission set driving a rotation of the rotating set. The rotating set includes a hollow sleeve pivotally disposed on the base and a rotating base fixed to the hollow sleeve. The rotating base has an accommodation space formed therein, and the accommodation space communicates with a hollow space defined in the hollow sleeve. Besides, the clamping set has a link axle penetrating through the hollow sleeve for providing an upward and downward movement, a link unit driven by the link axle, and two clamping units driven by the link unit and adapted to carry out a clamping action. Further, the transmission set includes a driving unit disposed on the hollow sleeve and a transmission unit driving a rotation of the driving unit. Accordingly, when the clamping set is driven by the rotating set, the link unit driven by the link axle activates an operation of the two clamping units to catch blanks. The driving unit rotated by the transmission unit makes the link axle, the rotating base and the clamping set rotatably turned in a clockwise or counterclockwise direction by 180 degrees at the same time, thereby adjusting a position of the holding device between the dies of the forming machine according to the need. Thus, this invention largely increases the smoothness of the processing operation, omits the unnecessary dies and attains a quick forming operation.

Preferably, each clamping unit comprises a clamping arm and a clamping jaw connected to the clamping arm.

Preferably, the rotating set comprises a bearing disposed around the hollow sleeve and located between the rotating set and the base.

The advantages of this invention over the known prior arts will become more apparent upon reading the following descriptions injunction with the accompanying drawings.

### BRIEF DESCRIPTION OF THE DRAWINGS

FIG. 1 is a schematic view showing a first preferred embodiment of this invention;

FIG. 2 is a cross-sectional view showing the first preferred embodiment of this invention;

FIG. 3-1 is a schematic view showing a catching status of the holding device of the first preferred embodiment of this invention;

FIG. 3-2 is a schematic view showing a releasing status the holding device of the first preferred embodiment of this invention; and

FIG. 4 is a schematic view showing that the link axle, the rotating base and the holding device of the first preferred embodiment of this invention turn by 180 degrees.

### DETAILED DESCRIPTION OF THE PREFERRED EMBODIMENTS

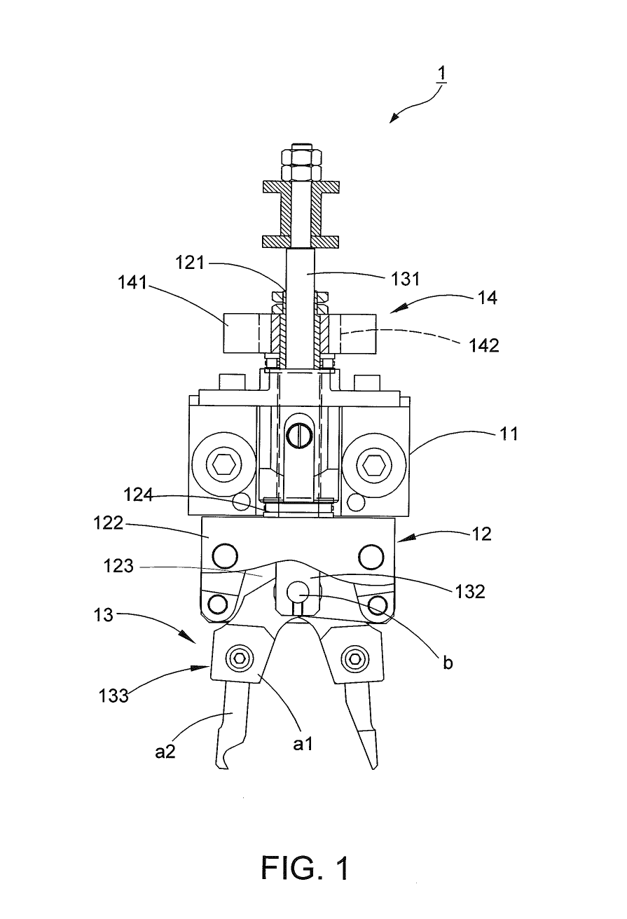

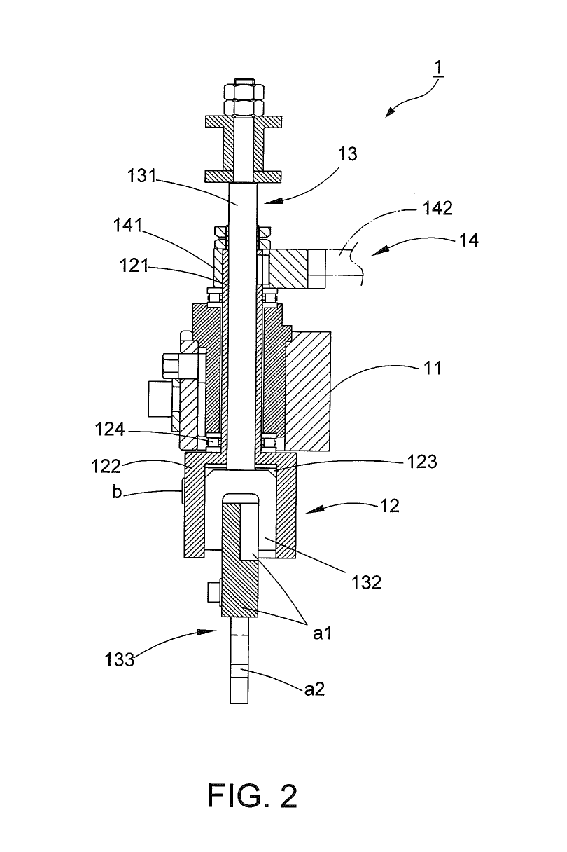

FIGS. 1 and 2 show a first preferred embodiment of a holding device 1 of this invention. The holding device 1 is disposed on a forming machine and is capable of moving between dies of the forming machine (not shown). The holding device 1 comprises a base 11, a rotating set 12 penetrating through the base 11, a clamping set 13 disposed under the base 11, and a transmission set 14 driving a rotation of the rotating set 12. The rotating set 12 includes a hollow sleeve 121 pivotally disposed on the base 11 and a rotating base 122 fixed to the hollow sleeve 121. The rotating base 122 has an accommodation space 123 formed therein, and the accommodation space 123 communicates with a hollow space defined in the hollow sleeve 121. In this preferred embodiment, it is preferable that the rotating set 12 has a bearing 124 disposed around or sleevedly disposed on the hollow sleeve 121 and located between the rotating base 122 and the base 11.

The clamping set 13 includes a link axle 131 penetrating through the hollow sleeve 121 for providing an upward and downward movement, a link unit 132 driven by the link axle 131, and at least two clamping units 133 driven by the link unit 132. Each of the clamping units 133 has a clamping arm a1 and a clamping jaw a2 connected to the clamping arm a1. Top ends of the two clamping arms a1 of the two clamping units 133 cross together and pivotally connected to the link unit 132 by a connecting unit b. The link unit 132 driven by the link axle 131 activates an operation of the two clamping units 133 in order to allow the clamp jaws a2 of the clamping units 133 to catch or release blanks (not shown).

Further, the transmission set 14 includes a driving unit 141 disposed on the hollow sleeve 121 and a transmission unit 142 driving a rotation of the driving unit 141. The link axle 131, the rotating base 122 and the clamping set 13 are concurrently rotatably turned in a clockwise or counterclockwise direction by 180 degrees by transmission set 14 in order to adjust a position of the holding device 1 between the dies of the forming machine according to the need.

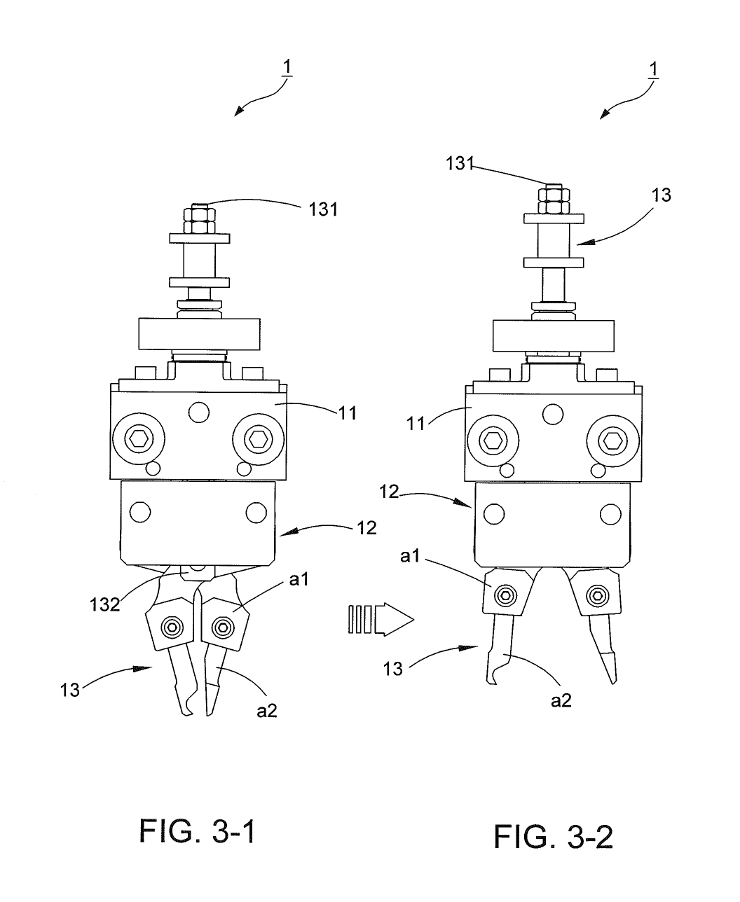

The use of this invention is described with the aid of FIGS. 2 and 3. The number of the holding device 1 depends on the number of dies of the forming machine. In other words, one holding device 1 can be disposed between any two sets of dies of the forming machine (not shown) if required. When the holding device 1 is driven by the forming machine to clamp a blank (not shown) which already experiences a first pressing process, the link axle 131 driven by the forming machine moves downward to swing the two crossed clamping arms a1 pivotally connected to the link unit 132. Thus, the clamping jaws a2 are closed by moving from outward to inward, thereby catching or gripping the blank, as shown in FIG. 3-1. Thereafter, the holding device 1 carries the blank to the next set of dies to press the other side of the blank.

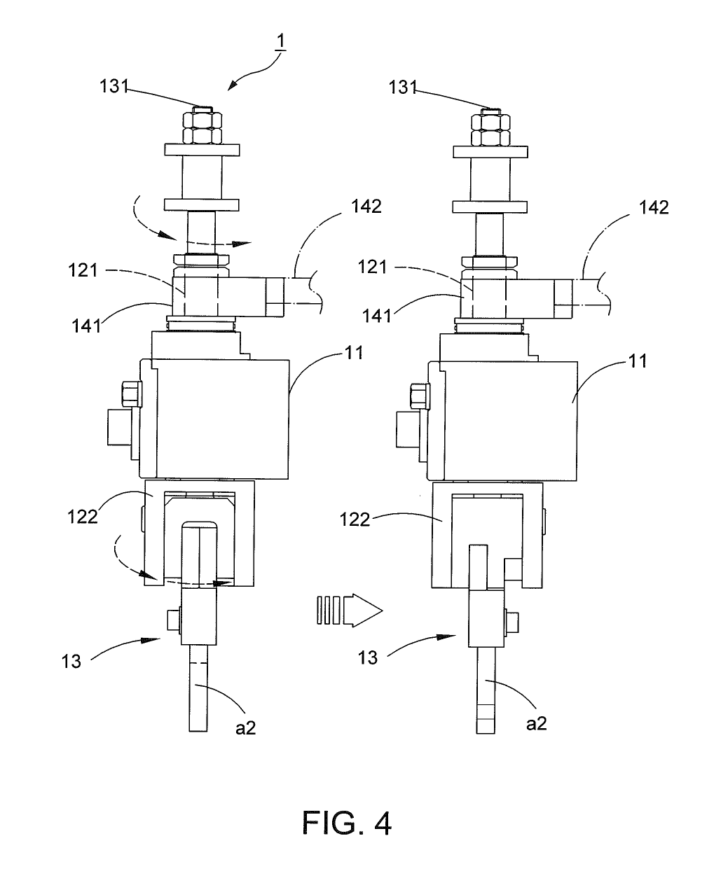

During the time that the holding device 1 moves to the next pressing process, the driving unit 141 disposed on the hollow sleeve 121 rotates under the control of the transmission unit 142. This rotation causes the link axle 131, the rotating base 122 and the clamping set 13 to be concurrently rotatably turned in a clockwise or counterclockwise direction by 180 degrees, as shown in FIG. 4. Accordingly, the clamping jaws a2 expose the side of the blank which is not pressed to the outside and simultaneously carry the blank to another place corresponding to another dies. When the other dies are going to press the blank, the link axle 131 driven by the forming machine moves upward and the link unit 132 drives the two clamping arms a1 again to allow the two clamping jaws a2 to open by swinging from inward to outward at the right place between the dies. Then, the aforesaid carried blank can be released from the clamping jaws a2, as shown in FIG. 3-2. Thus, the blank is pressed while the blank is released from the clamping jaws a2, and such pressing action is repeated in order to complete the press-forming operation. From above, because the rotating set 12, the clamping set 13 and the transmission set 14 are not fixed to the base 11, a catching and releasing operation and a clockwise or counterclockwise turning action by 180 degrees can be carried out in the multiple pressing operation in order to largely increase the smoothness of the processing operation. This invention can also be adapted to clamp and move special pressed blanks to a desired processing place. Therefore, this invention can efficiently lower the cost during the pressing operation and control the pressing speed to reduce the number of defective goods, increase the smoothness of the operation and attain a rapid forming operation.

To sum up, this invention takes advantage of the rotating set, the clamping set and the transmission set which are not fixed to the base to adjust a position of the holding device between the dies of the forming machine according to the need. Further, the holding device carries out a catching and releasing operation and a clockwise or counterclockwise turning action by 180 degrees to increase the smoothness of the multiple pressing operation, omit the unnecessary dies or tools to reduce the cost and attain a quick forming operation.

While the embodiments of this invention are shown and described, it is understood that further variations and modifications may be made without departing from the scope of this invention.

What is claimed is:

1. A holding device of a forming machine comprises a base, a rotating set penetrating through said base, a clamping set disposed under said base, and a transmission set driving a rotation of said rotating set, wherein said rotating set includes a hollow sleeve pivotally disposed on said base and a rotating base fixed to said hollow sleeve, said rotating base having an accommodation space formed therein, said accommodation space communicating with a hollow space which is defined in said hollow sleeve, said clamping set having a link axle penetrating through said hollow sleeve for providing an upward and downward movement, a link unit driven by said link axle, and two clamping units driven by said link unit for carrying out a clamping action, said transmission set including a driving unit disposed on said hollow sleeve and a transmission unit driving a rotation of said driving unit, said link axle, said rotating base and said clamping set being concurrently rotatably turned in a clockwise or counterclockwise direction by 180 degrees by said transmission set.

2. The holding device of the forming machine as claimed in claim 1, wherein each of said clamping units comprises a clamping arm and a clamping jaw connected to said clamping arm.

3. The holding device of the forming machine as claimed in claim 1, wherein said rotating set comprises a bearing disposed around said hollow sleeve and located between said rotating set and said base.
